(19) United States
(12) Patent Application Publication
(10) Pub. No.: US 2015/0116527 A1
(43) Pub. Date: Apr. 30, 2015

(54) COMPACT ARRAY CAMERA MODULES HAVING AN EXTENDED FIELD OF VIEW FROM WHICH DEPTH INFORMATION CAN BE EXTRACTED

(71) Applicant: Heptagon Micro Optics Pte. Ltd., Singapore (SG)

(72) Inventor: Markus Rossi, Jona (CH)

(21) Appl. No.: 14/526,664

(22) Filed: Oct. 29, 2014

Related U.S. Application Data
(60) Provisional application No. 61/898,041, filed on Oct. 31, 2013.

(51) Int. Cl. H04N 3/14

(52) U.S. Cl. CPC H04N 3/1593
USPC 348/218.1

(57) ABSTRACT

A compact camera module includes an image sensor including photosensitive areas, and an array of lenses optically aligned with sub-groups of the photosensitive areas. The array of lenses includes a first array of lenses and one or more groups of lenses disposed around the periphery of the first array of lenses. Each lens in the first array has a respective central optical axis that is substantially perpendicular to a plane of the image sensor and each of which has field of view. Each of the lenses in the one or more groups disposed around the periphery of the first array of lenses has a field of view that is centered about an optical axis that is tilted with respect to the optical axes of the lenses in the central array.

### CROSS-REFERENCE TO RELATED APPLICATION(S)

This application claims the benefit of priority of U.S. Provisional Patent Application No. 61/898,041, filed on Oct. 31, 2013, the contents of which are incorporated herein by reference in their entirety.

### FIELD OF THE DISCLOSURE

This disclosure relates to compact array camera modules having an extended field of view from which depth information can be extracted.

### BACKGROUND

Compact digital cameras can be integrated into various types of consumer electronics and other devices such as mobile phones and laptops. In such cameras, lens arrays can be used to concentrate light, imaged on a photodetector plane by a photographic objective, into smaller areas to allow more of the incident light to fall on the photosensitive area of the photodetector array and less on the insensitive areas between the pixels. The lenses can be centered over sub-groups of photodetectors formed into a photosensitive array. For many applications, it is desirable to achieve a wide field of view as well as good depth information.

### SUMMARY

The present disclosure describes compact array camera modules having an extended field of view from which depth information can be obtained.

For example, in one aspect, a compact camera module includes an image sensor including photosensitive areas, and an array of lenses optically aligned with respective sub-groups of the photosensitive areas. The array of lenses includes a first M×N array of lenses (where at least one of M or N is equal to or greater than two) each of which has a respective central optical axis that is substantially perpendicular to a plane of the image sensor and each of which has a field of view. In addition, one or more groups of lenses are disposed at least partially around the periphery of the first array of lenses, wherein each of the lenses in the one or more groups has a field of view centered about a respective optical axis that is tilted with respect to the central optical axes of the lenses in the first array.

In some implementations, the lenses in different sub-groups of the one or more groups of lenses have fields of view centered about respective optical axes that are tilted from the optical axes of the lenses in the first array by an amount that differs from lenses in other sub-groups such that each sub-group contributes to a different portion of the camera module's overall field of view. In some cases, the lenses in the one or more groups lenses laterally surround the entire first array of lenses.

Some implementations include circuitry to read out and process signals from the image sensor. In some cases, the circuitry is operable to obtain depth information based on output signals from sub-groups of photodetectors in the image sensor that detect optical signals passing through the lenses in the first array. Thus, a method of using the camera module can include obtaining depth information based on output signals from the light detecting elements that detect optical signals passing through the lenses in the first array. The depth information can be based, for example, on the parallax effect. In some implementations, an image can be displayed based on output signals from the light detecting elements that detect optical signals passing through the lenses in the first array and based on output signals from the light detecting elements that detect optical signals passing through the one or more groups of lenses disposed around the periphery of the first array.

The disclosure also describes an apparatus in which the camera module and circuitry are integrated into a personal computing device such as a mobile phone.

Other aspects, features and advantages will be readily apparent from the following detailed description, the accompanying drawings and the claims.

### BRIEF DESCRIPTION OF THE DRAWINGS

FIG. 1 shows a cut-away side view of an example of an array camera module.

FIG. 2 illustrates a top view of the lens array in the camera module of FIG. 1.

FIG. 3 illustrates a top view of a lens array camera module.

FIG. 4 is a cut-away side view of an example of an array camera module illustrating details of the optical axes and fields of view of the lenses.

FIG. 5 illustrates another example of an array camera module.

FIG. 6 illustrates yet another example of an array camera module.

FIG. 7 is a block diagram of a camera module integrated into a device such as a mobile phone.

### DETAILED DESCRIPTION

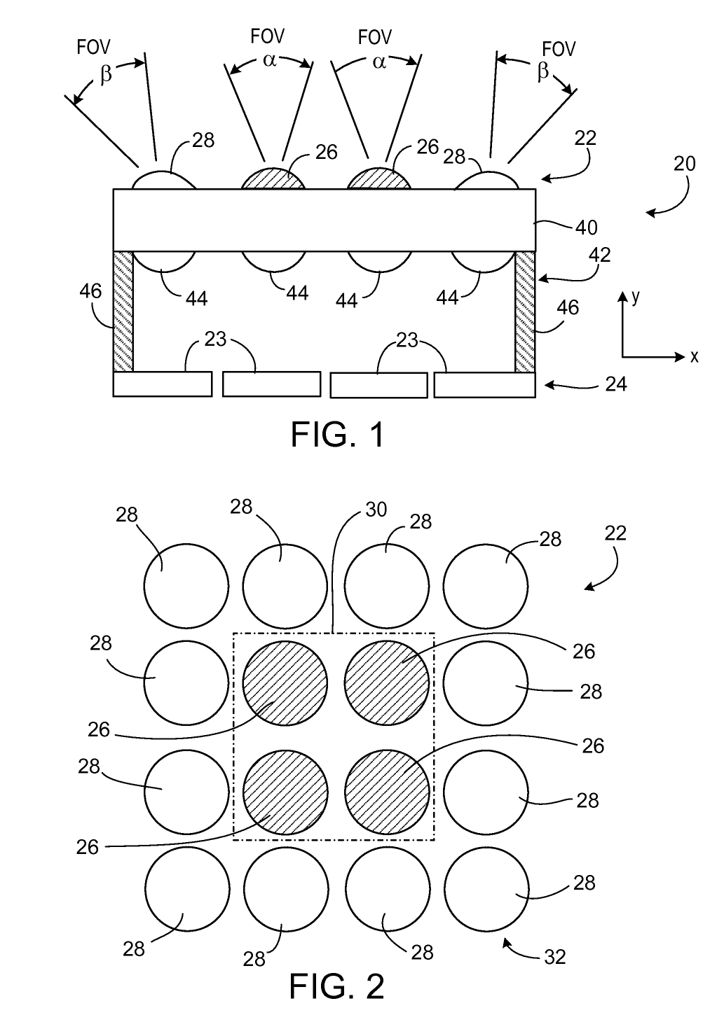

The present disclosure describes compact camera modules having an extended field of view from which depth information can be extracted. As shown in FIGS. 1 and 2, a camera 20 includes an array 22 of passive optical elements (e.g., microlenses) to concentrate light onto an array of photosensitive areas of an image sensor 24. The lens array 22 can be formed, for example, as an array of refractive/diffractive lenses or refractive microlenses which are located over sub-groups of the array of light-detecting elements 23 (e.g., photodetectors) that form the image sensor 24.

The illustrated array 22 of microlenses includes a center array 30 of microlenses 26 and one or more rings 32 of microlenses 28 that surround the center array 30. Although in some implementations the one or more rings 32 of microlenses 28 entirely surround the center array 30, in other implementations the one or more rings 32 of microlenses 28 may surround the center array, only partially. For example, the microlenses 28 may be present at only two or three sides of the center array 30. Thus, one or more groups of microlenses 28 are disposed partially or entirely around the periphery of the center array 30 of lenses 26. Each lens 26 in the center array has a central optical axis that is substantially perpendicular to the plane of the sensor array 24. On the other hand, each lens 28 in the surrounding one or more rings 32 has a central optical axis that is tilted (i.e., is non-parallel) with respect to the optical axes of the lenses 26 in the center array 30 and is substantially non-perpendicular with respect to the plane of the image sensor 24.

Each lens 26, 28 in the array 22 is configured to receive incident light of a specified wavelength or range of wavelengths and redirect the incident light to a different direction. Preferably, the light is redirected toward the image sensor 24 containing the light-detecting elements 23. In some implementations, each lens 26, 28 is arranged such that it redirects incident light toward a corresponding light-detecting element in the image sensor 24 situated below the lens array 22. Optical signals passing through the lenses 26 in the center array 30 and detected by the corresponding sub-groups of photodetectors 23 that form the photosensitive array 24 can be used, for example, to obtain depth information (e.g., based on the parallax effect), whereas optical signals passing through the lenses 28 in the one or more surrounding rings 32 can be used to increase the overall FOV of the camera. An output image may be obtained, for example, by photo stitching together the images obtained from each individual detecting element (e.g., by using image processing to combine the different detected images). Other techniques such as rectification and fusion of the sub-images can be used in some implementations.

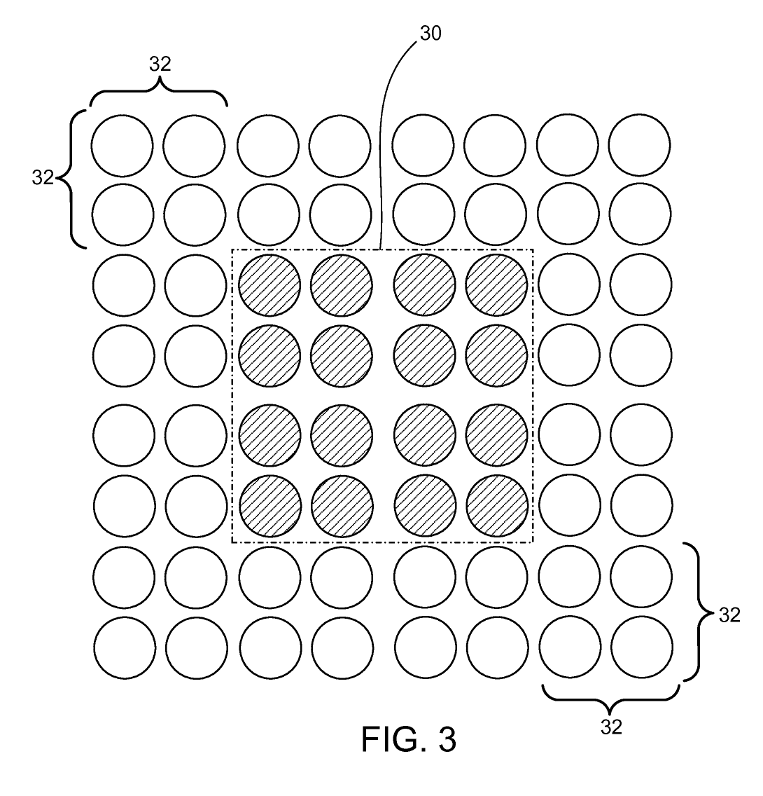

The size of the center array, M×N (where at least one of M or N≧2), can vary depending on the implementation. In the illustrated example of FIGS. 1 and 2, the center array 30 is a 2×2 array of four lenses 26. The number of surrounding rings 32 of lenses 28 also can depend on the implementation. In the example of FIGS. 1 and 2, there is only one outer ring 32 of twelve lenses 28. On the other hand, FIG. 3 illustrates an example in which the center array 30 is a 4×4 array, and there are two surrounding rings 32 of lenses 28. Thus, in the example of FIG. 3, there are sixteen lenses in the center array 30 and forty-eight lenses in the surrounding rings 32. Although in the illustrated examples the central arrays 30 are symmetric (i.e., M equals N), the dimensions of the center array can be selected such that M and N differ. In some implementations, the diameter of each microlenses 26, 28 is substantially the same and is in the range of 500 μm-5 mm or 200 μm-5 mm. Other sizes for the microlenses may be appropriate in other implementations.

The range of angles of incident light subtended by a particular lens 26, 28 in the plane of FIG. 1 (i.e., the x-y plane) and which the particular lens 26, 28 is configured to redirect to a corresponding light-detecting element represents the lens' “angular field of view,” or simply “field of view” (FOV) for short. Some of the lenses 26, 28 in the array 22 may have a different field of view from other lenses in the array 22. For example, in some implementations, a first lens has a FOV that is 35 degrees, a second lens may have a FOV that is 40 degrees, while a third lens may have a FOV that is 45 degrees. Other fields of view may also be possible. Although the FOV of each lens is shown just for the x-y plane in FIG. 1, the FOV may be the symmetric around the optical axis of each particular lens.

The FOV of each lens 26, 28 in the array 22 may cover different regions of space. To determine the region covered by the FOV of a particular lens, one looks at the angles subtended by the lens as measured from a fixed reference plane (such as the surface of the substrate 40, a plane that extends parallel with the substrate surface such as a plane extending along the horizontal x-axis in FIG. 1, or the image plane of image-sensor 24). Alternatively, one can define the range of angles with respect to the optical axis of the lens.

The lenses 26 in the center array 30 can be substantially the same as one another and can have a first FOV (α). The lenses 28 in the surrounding one or more rings 32 can have the same or a different FOV (β) that is optimized to extend the camera's overall FOV. The total range of angles subtended by all of the lenses 26, 28 in the array 22 defines the array's “overall field of view.” To enable the lens array 22, and thus the camera module 20, to have an overall field of view greater than the field of view of each individual lens, the central optical axes of the lenses can be varied. For example, although each lens 26, 28 may have a relatively small FOV (e.g., an FOV in the range of 20° to 60°), the combination of the lenses 26, 28 effectively expands the camera's overall FOV compared to the FOV of any individual lens. Thus, in a specific example, although the FOV of the lenses 26 in the central array 30 may be only in the range of about 30° to 40°, the camera module's overall FOV may be significantly greater because of the contribution by the lenses 28 in the surrounding rings 32 (e.g., 30° per each off-axis lens ring 28).

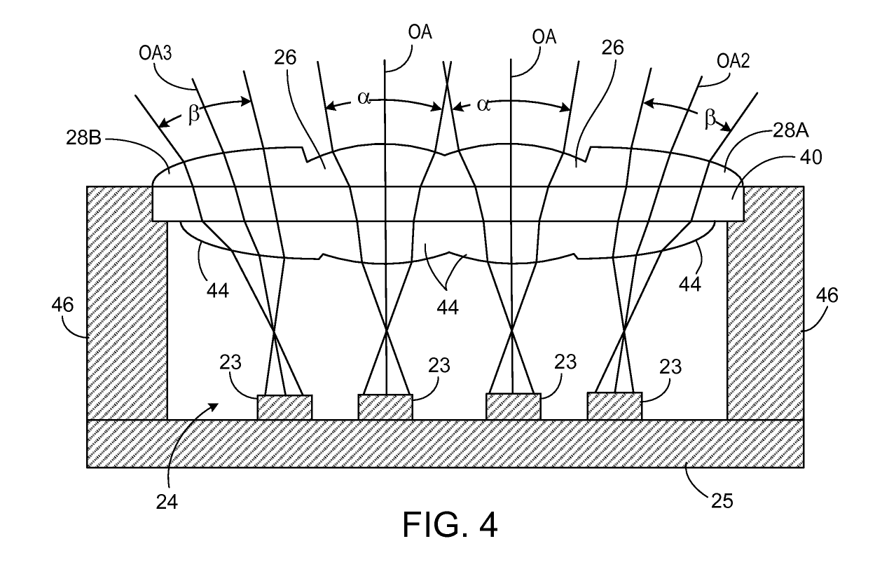

The FOV for a particular lens can be centered about the optical axis of the lens. Thus, as shown in the example of FIG. 4, each lens 26 has a FOV (α) centered about its respective optical axis (OA) which is substantially perpendicular to the image plane of the image sensor 24. In contrast, a lens 28A in an outer ring of lenses has a FOV (β) centered about its optical axis (OA2), which is not perpendicular to the image plane of the image sensor 24. Similarly, another lens 28B in an outer ring of lenses has the same FOV (β) centered about its optical axis (OA3), which also is not perpendicular to the image plane of the image sensor 24. Thus the lenses 26, 28 cover different regions of space, so that the overall FOV of the array 22 is greater than the FOV of any individual lens. That is, the overall FOV of the array 22 may be subdivided into smaller individual fields of view, each corresponding to a different lens 26, 28 in the array 22.

In some implementations, the lenses 28 in the surrounding rings 32 can differ from one another. Thus, for example, lenses 28 in different sub-groups can have fields of view centered about different optical axes such that each sub-group contributes to a different portion of the camera's overall field of view. In some cases, the FOV of each lens (or each sub-group of lenses) is optimized based on its position in the array 22. In some implementations, there may be some overlap in the fields of view of the lenses 26 in the central array 30 and the lenses 28 in the surrounding rings 32. There also can be some overlap in the fields of view of different sub-groups of lenses 28. In any event, each lens in the one or more surrounding groups can have a field of view that is not encompassed by the field of view of the lenses in the central array.

As shown in FIG. 1, the lenses 26, 28 in the array 22 can be attached or formed on a substrate 40. The substrate 40 can be composed, for example, entirely of a transparent material (e.g., a glass, sapphire or polymer material). Alternatively, the substrate 40 can be composed of transparent regions separated by regions of non-transparent material. In the latter case, the transparent regions extend through the thickness of the substrate 40 and correspond to the optical axes of the lenses 26, 28. In some implementations, color filters can be embedded within or provided on the transmissive portions of the substrate 40 so that different optical channels are associated with different colors (e.g., red, green or blue). The lenses 26, 28 can be composed, for example, of a plastic material and can be formed, for example, by replication, vacuum molding or injection molding. In some implementations, in addition to the lens array 22, the sensor-side of the substrate 40 can include a second lens array 42 (see FIG. 1). The combination of lens arrays 22, 42 focuses the incoming light signals on the corresponding photodetector(s) in the image sensor 24. Each lens 44 in the second array 42 can be aligned substantially with a corresponding lens 26, 28 in the first array 22 so as to form a vertical lens stack. The combination of each pair of lenses focuses the incoming light signal on a corresponding light-detector element(s) 23 in the image sensor 24. In some implementations, the area of each lens array 22, 42 is greater than the area of the image sensor 24 (see, e.g., FIG. 4).

The image sensor 24 can be mounted on or formed in a substrate 25. The lens substrate 40 can be separated from the image sensor 24, for example, by non-transparent spacers 46 that also serves as sidewalls for the camera. In some implementations, non-transparent spacers also separate adjacent optical channels from one another. The spacers can be composed, for example, of a polymer material (e.g., epoxy, acrylate, polyurethane, or silicone) containing a non-transparent filler (e.g., a pigment, inorganic filler, or dye). In some implementations, the spacers are provided as a single spacer wafer, with openings for the optical channels, made by a replication technique. In other implementations, the spacers can be formed, for example, by a vacuum injection technique in which case the spacer structures are replicated directly onto a substrate. Some implementations include a non-transparent baffle over the module so as to surround the individual lenses 26, 28 and prevent or limit stray light from entering the camera and being detected by the image sensor 24. The baffle also can be provided either as a separate spacer wafer or by using a vacuum injection technique

The image sensor 24 can be implemented, for example, as a photodiode, CMOS, or CCD array that has sub-groups of photodetectors corresponding to the number of lenses 26, 28 forming the array 22. In some implementations, some of the photodetector elements in each sub-group are provided with a color filter (e.g., monochromous (red, green or blue), Bayer, infra-red or neutral density).

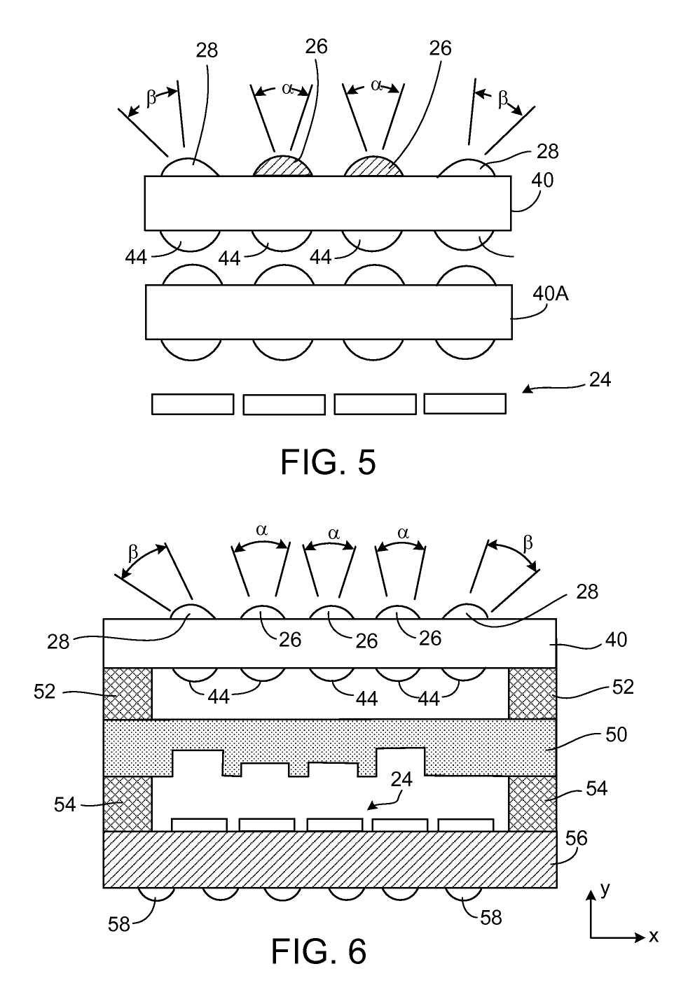

As shown in FIG. 5, some camera modules include a vertical stack of two or more transparent substrates 40, 40A, each of which includes an array of optical elements (e.g., lenses) on one or both sides. At least one of the lens arrays in the vertical stack is similar to the array 22 described above (i.e., a central array 30 and one or more surrounding rings 32).

FIG. 6 illustrates another example of an array camera module that incorporates the lens array 22 as well as a flange focal length (FFL) correction substrate 50. The FFL correction substrate 50 can be composed, for example, of a transparent material that allows light within a particular wavelength range to pass with little or no attenuation. The FFL substrate 50 can be separated from the lens substrate 40 by a non-transparent spacer 52. Prior to attaching the image sensor 24, the thickness of the FFL correction substrate 50 at positions corresponding to particular optical channels can be adjusted to correct for differences in the FFL of the optical channels. Thus, the thickness of the FFL correction substrate 50 may vary for the different optical channels within the same module. The image sensor 24, which can be mounted on a substrate 56, can be separated from the FFL correction substrate, for example, by another non-transparent spacer 54. The height of spacer 54 also can be adjusted so as to correct for FFL offsets.

In some implementations, non-transparent spacers also can be used within the camera module to separate adjacent optical channels from one another, where an optical channel is defined as the optical pathway followed by incident light through a lens (or lens-pair) of the lens module and to a corresponding light-detecting element of the image sensor 24. Such spacers can be composed, like spacers 46, of a polymer material (e.g., epoxy, acrylate, polyurethane, or silicone) containing a non-transparent filler (e.g., a pigment, inorganic filler, or dye). In some implementations, the spacers are provided as a single spacer wafer, with openings corresponding to the optical channels, made by a replication technique. In other implementations, the spacers can be formed, for example, by a vacuum injection technique in which the spacer structures are replicated directly onto a substrate. Some implementations include a non-transparent baffle on a side of the transparent substrate 40 module. Such a baffle can surround the individual lenses and prevent or limit stray light from entering the camera and being detected by the image-sensor 24. The baffle also can be provided as a separate spacer wafer or by using vacuum injection technique. The foregoing features can be included in the implementations of FIGS. 1 and 5 as well.

The camera module can be mounted, for example, on a printed circuit board (PCB) substrate. Solder balls or other conductive contacts such as conductive pads 58 on the underside of the camera module can provide electrical connections to the PCB substrate. The image sensor 24 can be implemented as part of an integrated circuit (IC) formed as, for example, a semiconductor chip device and which includes circuitry that performs processing (e.g., analog-to-digital processing) of signals produced by the light-detecting elements. The light-detecting elements may be electrically coupled to the circuitry through electrical wires (not shown). Electrical connections from the image sensor 24 to the conductive contacts 58 can be provided, for example, by conductive plating in through-holes extending through the substrate 56. The foregoing features can be included in the implementations of FIGS. 1 and 5 as well.

Multiple array-camera modules, as described above, can be fabricated at the same time, for example, in a wafer-level process. Generally, a wafer refers to a substantially disk- or plate-like shaped item, its extension in one direction (y-direction or vertical direction) is small with respect to its extension in the other two directions (x- and z- or lateral directions). On a (non-blank) wafer, multiple similar structures or items can be arranged, or provided therein, for example, on a rectangular or other shaped grid. A wafer can have openings or holes, and in some cases a wafer may be free of material in a predominant portion of its lateral area. In some implementations, the diameter of the wafer is between 5 cm and 40 cm, and can be, for example, between 10 cm and 31 cm. The wafer may be cylindrical with a diameter, for example, of 2, 4, 6, 8, or 12 inches, one inch being about 2.54 cm. The wafer thickness can be, for example, between 0.2 mm and 10 mm, and in some cases, is between 0.4 mm and 6 mm. In some implementations of a wafer level process, there can be provisions for at least ten modules in each lateral direction, and in some cases at least thirty or even fifty or more modules in each lateral direction.

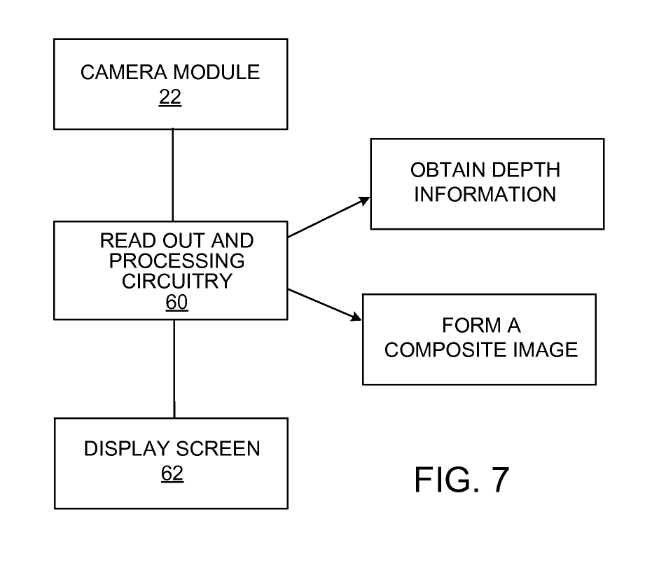

As shown in FIG. 7, a mobile phone or other electronic device into which the camera module is integrated can include circuitry 60 for reading out and processing signals from the image sensor 24. Such circuitry can include, for example, one or more data buses, as well as column and row address decoders to read out signals from individual pixels in the image sensor 24. The circuitry can include, for example, analog-to-digital converters, sub-image pixel inverters, and/or non-volatile memory cells, as well multiplexers and digital clocks. Among other things, based on output signals from sub-groups of the photodetectors in the image sensor 24 that detect optical signals passing through the lenses 26 in the central array 30, the circuitry can obtain depth information using known techniques (e.g., based on the parallax effect). The circuitry can process the signals from all the pixels in the image sensor 24 to form a single composite image that can be displayed, for example, on the mobile phone's display screen 62.

In the context of this disclosure, when reference is made to a particular material or component being transparent, it generally refers to the material or component being substantially transparent to light detectable by the image sensor 24. Likewise, when reference is made to a particular material or component being non-transparent, it generally refers to the material or component being substantially non-transparent to light detectable by the image sensor 24.

Various modifications can be made within the spirit of the invention. Accordingly, other implementations are within the scope of the claims.

What is claimed is:

1. A compact camera module comprising:
an image sensor including photosensitive areas; and
an array of lenses optically aligned with respective sub-groups of the photosensitive areas, the array of lenses including:
a first array of lenses each of which has a respective central optical axis that is substantially perpendicular to a plane of the image sensor and each of which has a field of view, wherein the first array is a M×N array where at least one of M or N is equal to or greater than two; and
one or more groups of lenses disposed at least partially around the periphery of the first array of lenses, wherein each of the lenses in the one or more groups has a field of view centered about a respective optical axis that is tilted with respect to the central optical axes of the lenses in the first array.

2. The camera module of claim 1 wherein each lens has a diameter in the range of 200 μm-5 mm.

3. The camera module of claim 1 wherein lenses in different sub-groups of the one or more groups of lenses have fields of view centered about respective optical axes that are tilted from the optical axes of the lenses in the first array by an amount that differs from lenses in other sub-groups such that each sub-group contributes to a different portion of the camera module's overall field of view.

4. The camera module of claim 1 further including a spacer that separates the image sensor from the array of lenses.

5. The camera module of claim 4 further including a FFL correction substrate disposed between the image sensor from the array of lenses.

6. The camera module of claim 1 wherein each of M and N is equal to or greater than two.

7. A compact camera module comprising:
an image sensor; and
an array of lenses disposed over the image sensor, the array of lenses including:
a central array of lenses each of which has a respective central optical axis that is substantially perpendicular to a plane of the image sensor, wherein the central array is a M×N array where at least one of M or N is equal to or greater than two; and
one or more groups of lenses laterally surrounding the central array of lenses at least partially, wherein at least some of the lenses in the one or more groups surrounding the central array have a respective field of view centered about a respective optical axis that is not substantially perpendicular to the plane of the image sensor.

8. The camera module of claim 7 wherein different sub-groups of the lenses in the one or more groups laterally surrounding the central array of lenses have different fields of view from one another.

9. The camera module of claim 7 wherein each of the lenses in the central array has a first field of view and wherein the lenses in the one or more surrounding groups have a different field of view.

10. The camera module of claim 7 wherein lenses in different sub-groups have fields of view centered about different optical axes such that each sub-group contributes to a different portion of the camera's overall field of view.

11. The camera module of claim 7 wherein the lenses in the one or more surrounding groups have respective fields of view that expand the camera module's field of view of beyond the field of view of the lenses in the central array.

12. The camera module of claim 7 wherein each lens has a diameter in the range of 200 μm-5 mm.

13. The camera module of claim 7 wherein lenses in different sub-groups of the one or more surrounding groups have differing fields of view from lenses in other sub-groups such that each sub-group contributes to a different portion of the camera module's overall field of view.

14. The camera module of claim 7 wherein the lenses are disposed over sub-groups of photodetectors in the image sensor.

15. The camera module of claim 7 further including a spacer that separates the image sensor from the array of lenses.

16. The camera module claim 15 further including a FFL correction substrate disposed between the image sensor from the array of lenses.

17. The camera module of claim 7 wherein each of M and N is equal to or greater than two.

18. A method of operating a compact camera module, the method comprising:
detecting optical signals received by light detecting elements in an image sensor, wherein some of the light detecting elements detect optical signals passing through a first array of lenses each of which has a respective central optical axis that is substantially perpendicular to a plane of the image sensor and each of which has field of view, wherein the first array is a M×N array where at least one of M or N is equal to or greater than two, and wherein others of the light detecting elements detect optical signals passing through one or more groups of lenses disposed at least partially around the periphery of the first array of lenses, wherein each lenses in the one or more groups has a respective field of view that is centered about an optical axis that is non-parallel with respect to the optical axes of the lenses in the first array;
obtaining depth information based on output signals from the light detecting elements that detect optical signals passing through the lenses in the first array; and
displaying an image based on output signals from the light detecting elements that detect optical signals passing through the lenses in the first array and based on output signals from the light detecting elements that detect optical signals passing through the one or more groups of lenses disposed around the periphery of the first array.

19. The method of claim 18 wherein each of M and N is equal to or greater than two.
